(19) United States
(12) Patent Application Publication
(10) Pub. No.: US 2012/0316781 A1
(43) Pub. Date: Dec. 13, 2012

(54) DISPLAY DEVICE OF A MOTOR VEHICLE

(75) Inventors: Lutz Krauss, Karlsruhe (DE); Timo Seehaus, Steinheim (DE); Thomas Mim, Leonberg (DE); Joerg Meyer-Ebeling, Stuttgart (DE); Albrecht Boettiger, Grafenau-Doeffingen (DE); Rolf Hartmann, Stuttgart (DE)

(73) Assignee: DR. ING. H.C. F. PORSCHE AKTIENGESELLSCHAFT, Stuttgart (DE)

(21) Appl. No.: 13/581,024

(22) PCT Filed: Jan. 28, 2011
(86) PCT No.: PCT/EP11/00396

§ 371 Date: Aug. 24, 2012

(30) Foreign Application Priority Data
Feb. 25, 2010 (DE) 10 2010 010 445.0

(51) Int. Cl. G01C 21/36

(52) U.S. Cl. 701/454

(57) ABSTRACT

A display device for a hybrid motor vehicle is configured to display a map that corresponds to a current vehicle position as controlled by a navigation device and to show at least two regions on the map. The regions include a first region that is reachable by the motor vehicle using available electrical energy when driving under purely electromotive power, and a second region that is reachable by the motor vehicle using an available quantity of fuel when driving under at least one of purely internal combustion engine power or combined electromotive power and internal combustion engine power.

### CROSS REFERENCE TO RELATED APPLICATIONS

This application is a U.S. National Phase application under 35 U.S.C. §371 of International Application No. PCT/EP2010/000396, filed on Jan. 28, 2011, and claims benefit to German Patent Application No. DE 10 2010 010 445.0, filed on Feb. 25, 2010. The International Application was published in German on Sep. 1, 2011, as WO 2011/103956 A1 under PCT Article 21 (2).

### FIELD

The invention relates to a display device of a motor vehicle.

### BACKGROUND

A large number of display devices, for example a speed display device, a rotation speed display device and a display device for displaying the filling volume of a fuel tank and for displaying an average fuel consumption, are installed in motor vehicles. Furthermore, motor vehicles which have a display device of a navigation device which can display a map depending on a current vehicle position are already known from practice. Display devices with the aid of which the state of charge of an electrical energy storage means can be displayed are also known from hybrid vehicles.

### SUMMARY

In an embodiment, the present invention provides a display device for a hybrid motor vehicle that is configured to display a map that corresponds to a current vehicle position as controlled by a navigation device and to show at least two regions on the map. The regions include a first region that is reachable by the motor vehicle using available electrical energy when driving under purely electromotive power, and a second region that is reachable by the motor vehicle using an available quantity of fuel when driving under at least one of purely internal combustion engine power or combined electromotive power and internal combustion engine power.

### BRIEF DESCRIPTION OF THE DRAWINGS

Exemplary embodiments of the present invention are explained in greater detail below with reference to the drawings, in which:

FIG. 1 shows a display device of a motor vehicle, specifically of a hybrid vehicle;

FIG. 2 shows a schematic illustration of a display device according to the invention of a motor vehicle, specifically of a hybrid vehicle, in a first state;

FIG. 3 shows the display device of FIG. 2 in a second state; and

FIG. 4 shows the display device of FIG. 2 in a third state.

### DETAILED DESCRIPTION

The present invention provides a novel display device of a motor vehicle having an extended functionality.

In an embodiment, the present invention provides a display device showing at least two regions on the map depending on the available quantity of fuel and depending on the available electrical energy, specifically a first region which can be reached using the available electrical energy when driving under purely electromotive power, and a second region which can additionally be reached using the available quantity of fuel when driving under purely internal combustion engine power and/or when driving under combined electromotive power and internal combustion engine power.

The present invention proposes for the first time designing a display device, which serves to display a map which corresponds to the current vehicle position, in such a way that at least two regions can be shown on the map depending on the available quantity of fuel and depending on the available electrical energy.

Therefore, a first region, which can be reached using the available electrical energy when driving under purely electromotive power, can be shown on the map. Furthermore, a second region, which can be reached using the available quantity of fuel when driving under purely internal combustion engine power and/or when driving under combined electromotive power and internal combustion engine power, can be shown on the map. As a result, it is possible to assist the driving behavior of a driver of a hybrid vehicle. The radius of action of the motor vehicle when driving under purely electromotive power and furthermore when driving using the internal combustion engine is directly visible to a driver. As a result, it is easier for the driver to adapt his driving behavior for the purpose of range optimization.

The display device preferably also shows the regions depending on the past and/or current driving style of the driver and/or depending on an activated mode of operation of the motor vehicle on the map. When the regions are also shown depending on the driving style and the mode of operation of the motor vehicle, said regions are more accurate and allow the driver to even better adapt his driving behavior.

According to an advantageous development of the invention, the display device shows the regions in different display modes, in particular in different colors. When the different regions are shown in different display modes on the map, it is particularly easy for the driver to make a distinction or orient himself

The display device preferably shows charging stations and/or gas stations within the regions in said regions. When charging stations and/or gas stations are additionally shown in the regions, the driver can adapt his driving behavior in a particularly advantageous manner.

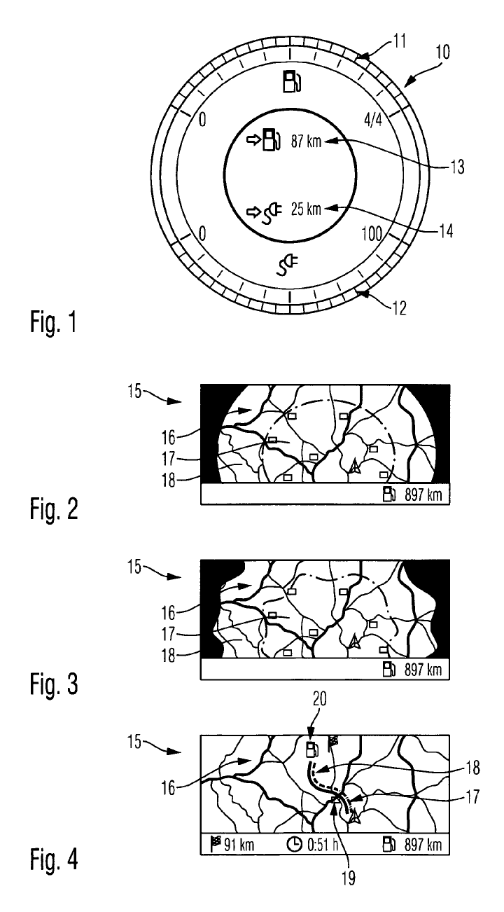

FIG. 1 shows a display device 10 of a motor vehicle, which display device displays a filling level of a fuel tank, and therefore an available quantity of fuel, in a first display region 11, and a state of charge of an electrical energy storage means, and therefore an available electrical energy, in a second display region 12. The display device 10 of FIG. 1 also has a display region 13 in which a range can be displayed using the fuel. A range which can be realized using the available electrical energy can also be displayed in a display region 14 of the display device 10 of FIG. 1.

FIGS. 2 to 4 show different states of a display device 15 according to the invention of a motor vehicle which is in the form of a hybrid vehicle, it being possible for a map 16 which corresponds to a current vehicle position to be displayed in a manner controlled by a navigation device (not shown) by means of said display device.

The display device 15 according to the invention shows at least two regions on the map 16 depending on the available quantity of fuel and depending on the available electrical energy, specifically a first region 17 which can be reached only using the available electrical energy when driving under purely electric or purely electromotive power, and a second region 18 which can additionally be reached using the available quantity of fuel when driving under internal combustion engine power or when driving under combined electromotive power and internal combustion engine power.

In the exemplary embodiment of the invention shown in FIG. 2, the display device 15 shows the regions 17 and 18 independently of routes, which are available in principle, in the form of concentric segments of a circle or areas of a segment of a circle when no specific route of the hybrid vehicle is activated in the navigation device (not shown), with the inner segment 17 of a circle or the inner area 17 of a segment of a circle showing the radius of action of the motor vehicle using the available electrical energy when driving under purely electrical power, and with the outer segment 18 of a circle or the outer area 18 of a segment of a circle, which area concentrically surrounds the inner area 17 of a segment of a circle, showing the radius of action of the hybrid vehicle which can be reached using the available quantity of fuel using the internal combustion engine when driving under internal combustion engine power or when driving under combined electromotive and internal combustion engine power. Regions of the map which are situated outside the second region 18 cannot be reached either using the available quantity of fuel or using the available electrical energy and are preferably completely hidden.

In the exemplary embodiment shown in FIG. 3, when no specific route of the hybrid vehicle is activated in the navigation device, the regions 17 and 18 are shown depending on routes which are available in principle, that is to say not in the form of concentric segments of a circle or areas of a segment of a circle but rather as two-dimensionally contoured curves or areas of which the respective extent is dependent on the route lengths which are available in principle. The region 17 again shows the radius of action of the motor vehicle using the available electrical energy when driving under purely electric power. The region 18 again shows the radius of action of the motor vehicle using the available quantity of fuel.

FIG. 4 shows a variant of the display device 15 according to the invention which, when a specific route is activated in the navigation device, shows the regions 17 and 18 as route sections of the activated route on the map 16. The route section 17 can be reached purely using the available electrical energy when driving under purely electric power. The route section 18 requires the use of the internal combustion engine.

The display device 15 according to the invention preferably indicates the regions 17 and 18 which are shown on the map 16 in different display modes, for example in different colors. By way of example, the first region 17, which can be reached using available electrical energy when driving under purely electromotive power, can be shown in a first color, for example in green, on the map. The second region 18, which can be reached using the available quantity of fuel when driving under purely internal combustion engine power or when driving under combined electromotive and internal combustion engine power, can be shown in a second color, for example in red, on the map 16. This allows a driver to orient himself in a particularly simple manner.

According to an advantageous development, the display device 15 additionally shows charging stations 19 and gas stations 20 which are situated within the regions 17 and 18 in said regions.

As already mentioned, the display device 15 shows the regions 17 and 18 on map 16 depending on the available quantity of fuel and depending on the available electrical energy. This information can additionally be shown depending on the past and/or current driving style of the driver and/or depending on an activated mode of operation of the motor vehicle. This results in particularly accurate assistance which is particularly helpful to a driver and allows the driver to adapt his driving behavior in order to drive so as to maximize the range and in order to thus reliably reach a charging station or gas station.

The display device 15 according to the invention accordingly interacts with a navigation device, with a control device which is associated with the display device generating the regions 17 and 18 which are to be shown on the map 16, specifically as already explained, depending on the available electrical energy, depending on the available quantity of fuel, depending on the activation or non-activation of a specific route in the navigation device and possibly depending on data about the driving style and/or the mode of operation of the motor vehicle.

When a specific route of the navigation device is activated, the regions 17 and 18 can also be shown depending on data about the route covered, specifically in particular depending on topography data about a height profile of the route, in order to take into account, for example, a recuperation potential of the route which can be used during generator operation of the or each electrical machine of the hybrid drive for charging an electrical energy storage means in connection with the available electrical energy.

While the invention has been particularly shown and described with reference to preferred embodiments thereof, it will be understood by those skilled in the art that various changes in form and details may be made therein without departing from the spirit and scope of the invention.

1-10. (canceled)

11. A display device for a hybrid motor vehicle, the display device being configured to display a map that corresponds to a current vehicle position as controlled by a navigation device, and to show at least two regions on the map comprising:
a first region that is reachable by the motor vehicle using available electrical energy when driving under purely electromotive power; and
a second region that is reachable by the motor vehicle using an available quantity of fuel when driving under at least one of purely internal combustion engine power or combined electromotive power and internal combustion engine power.

12. The display device recited in claim 11, wherein the display device is configured to display the first and second regions independently of available routes when no specific route is activated in the navigation device.

13. The display device recited in claim 12, wherein the display device is configured to show the first and second regions as concentric circles, segments of a circle, areas of a circle or areas of a segment of a circle.

14. The display device recited in claim 12, wherein the display device is configured to show the first and second regions as two-dimensionally contoured curves or areas.

15. The display device, recited in claim 11, wherein the display device is configured to show, when a specific route is activated in the navigation device, the first and second regions as route sections of the activated specific route.

16. The display device recited in claim 11, further comprising, a control device configured to:
generate the first and second regions depending on the available quantity of fuel, the available electrical energy and the activation or non-activation of a specific route, and
show the first and second regions on the map.

17. The display device recited in claim 16, wherein the control device is further configured to generate the first and second regions based on at least one of past driving style of the driver, current driving style of the driver, and an activated mode of operation of the motor vehicle.

18. The display device recited in claim 11, wherein the display device is configured to display first and second regions in different display modes.

19. The display device recited in claim 18, wherein the display device is configured to display the first and second regions in different colors.

20. The display device recited in claim 11, wherein the display device is configured to display at least one of charging stations or gas stations within at least one of the first and second regions.
